(19) United States
(12) Patent Application Publication
(10) Pub. No.: US 2024/0281269 A1
(43) Pub. Date: Aug. 22, 2024

(54) COMPUTER AND METHOD

(71) Applicant: Toshiba Tec Kabushiki Kaisha, Tokyo (JP)

(72) Inventor: Naoya SATO, Izunokuni Shizuoka (JP)

(21) Appl. No.: 18/410,728

(22) Filed: Jan. 11, 2024

(30) Foreign Application Priority Data
Feb. 22, 2023 (JP) 2023-026504

(51) Int. Cl. G06F 9/455; G06F 8/30

(52) U.S. Cl. CPC G06F 9/45508; G06F 8/315

(57) ABSTRACT

According to one embodiment, a computer includes a CPU and a storage device. The storage device stores an operating system that executes a bytecode without optimization for an extended ISA supported by the CPU unless the extended ISA is designated in a command line argument for executing the bytecode. The storage device further stores a correspondence table showing a correspondence between a value of an extension field indicating the extended ISA and the command line argument enabling optimization corresponding to the extended ISA. A program in the storage device is configured to cause the CPU to acquire an ISA supported by the CPU, acquire the extended ISA from the ISA, refer to the correspondence table to acquire the command line argument associated with the extended ISA, and then automatically include the command line argument associated with the extended ISA when executing the bytecode.

### CROSS-REFERENCE TO RELATED APPLICATION

This application is based upon and claims the benefit of priority from Japanese Patent Application No. 2023-026504, filed Feb. 22, 2023, the entire contents of which are incorporated herein by reference.

### FIELD

Embodiments described herein relate to a computer that executes a bytecode and a method of executing a bytecode on a computer.

### BACKGROUND

There is a system in which a just-in-time compiler generates and optimizes a native code from a bytecode group presented to the compiler.

In addition, there is a system that executes a bytecode but when an extended instruction set architecture (ISA) supported by a CPU is not designated in a command line argument of the system, a just-in-time compiler cannot generate an optimal native code for the extended ISA supported by the CPU.

In the system in which the just-in-time compiler generates and optimizes the native code from the bytecode group presented to the compiler, and in the system that executes the bytecode but without optimization when the extended ISA supported by the CPU is not manually designated in the command line argument, the just-in-time compiler cannot generate and optimize the native code since there is no method for setting the command line argument.

### BRIEF DESCRIPTION OF THE DRAWINGS

FIG. 1 illustrates a hardware configuration of a computer according to an embodiment.

FIG. 2 illustrates a schematic software configuration.

FIG. 3 illustrates an ID register included in a CPU.

FIG. 4 illustrates a Base field.

FIG. 5 illustrates an Extensions field.

FIG. 6 illustrates an ISA-command line correspondence table.

FIG. 7 is a flowchart illustrating a process executed by a Java virtual machine calling unit.

FIG. 8 illustrates an execution command of Java virtual machine calling unit.

FIG. 9 illustrates an actual command for calling a Java virtual machine.

### DETAILED DESCRIPTION

In general, according to certain embodiments, an improved computer system in which optimal native code for an extended instruction set architecture by automatic inclusion of a command line argument for execution of a bytecode or the like and an improved method for executing a bytecode in a computer system in which an optimal native code is generated for a system with an extended instruction set architecture.

According to one embodiment, a computer includes a central processing unit (CPU) and a storage device. The storage device stores an operating system that executes a bytecode without optimization for an extended ISA supported by the CPU unless the extended ISA is designated in a command line argument for executing the bytecode. The storage device further stores: a correspondence table showing a correspondence between a value of an extension field indicating the extended ISA and the command line argument enabling optimization corresponding to the extended ISA and a program. The program is configured to cause the CPU to: acquire an ISA supported by the CPU, acquire the extended ISA from the ISA, refer to the correspondence table to acquire the command line argument associated with the extended ISA, and automatically include the command line argument associated with the extended ISA when executing the bytecode.

### Hardware Configuration

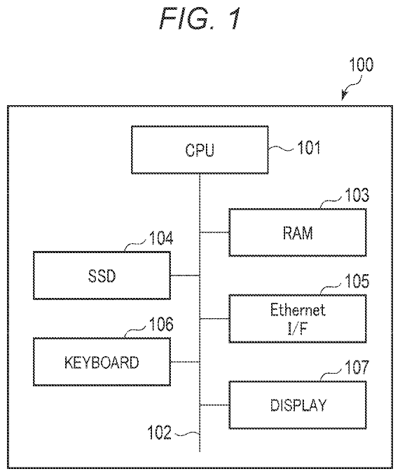

First, a hardware configuration of a computer 100 according to an embodiment will be described with reference to FIG. 1. FIG. 1 illustrates a hardware configuration of the computer 100. The computer 100 is, for example, a general purpose computer. The computer may be a personal computer, a server computer, or the like.

The computer 100 includes a CPU 101, a bus 102, a RAM 103, a solid state drive (SSD) 104, an Ethernet interface (I/F) 105, a keyboard 106, and a display 107. The computer 100 may include other devices or components in addition to those referenced above.

The CPU 101 is, for example, a RISC-V CPU (sometimes pronounced “risk-five,” and refers here to an open standard instruction set architecture). For example, the RISC-V CPU has an ISA of RV64IMAFDC, a basic ISA has RV64I, and an extended ISA has MAFDC.

An association between the ISA of RISC-V and alphabetic characters representing the ISA is described in “riscv-privileged.pdf” of “https://github.com/riscv/riscv-isa-manual/releases”.

Here, the example in which the CPU 101 is a RISC-V CPU is described, but other CPUs may be used as long as the CPU has an optional or additional instruction set other than a basic instruction set, such as an extension instruction set or a dedicated instruction set similarly to a RISC-V CPU.

The CPU 101, the RAM 103, the solid state drive 104, the Ethernet interface 105, the keyboard 106, and the display 107 are electrically connected to one another via the bus 102, and exchange instructions, programs, and data via the bus 102.

The CPU 101 is a hardware processor, and controls the RAM 103, the solid state drive 104, the Ethernet interface 105, the display 107, and the keyboard 106.

The RAM 103 is a main memory that temporarily stores programs and data as necessary for a process to be executed by the CPU 101.

The solid state drive 104 is an auxiliary storage device that can store programs and data such as those temporarily stored in the RAM 103. The solid state drive 104 generally stores programs and data in a persistent (non-temporary) manner.

The CPU 101 reads the programs and data in the solid state drive 104 into the RAM 103, and executes various functions by executing the programs.

The display 107 is an output device to which data is sent (output). The display 107 notifies a user of various types of information.

The keyboard 106 is an input device that receives instructions and data inputs from a user or the like. The keyboard 106 receives instructions and data by an operation of the user.

The Ethernet interface 105 is more broadly a communication interface for connecting to a network or other devices. For example, the computer 100 can be connected to a network or other devices via the Ethernet interface 105.

The bus 102, the RAM 103, the solid state drive 104, the Ethernet interface 105, the keyboard 106, and the display 107 may be of standard designs.

### Software Configuration

The computer 100 operates by reading an operating system stored in the solid state drive 104 into the RAM 103 at startup. For example, the operating system is Linux. Hereinafter, an example in which the operating system is Linux will be described, but the operating system is not limited thereto, and may be another operating system type.

A schematic software configuration of the computer 100 will be described below with reference to FIG. 2. FIG. 2 illustrates an example software configuration of the computer 100. Specifically, FIG. 2 illustrates a schematic configuration of a Linux operating system (OS) 201 stored in the solid state drive 104.

The solid state drive 104 stores the Linux OS 201. The Linux OS 201 is preferably, for example, a Debian GNU/Linux distribution operating in the RISC-V CPU.

The Linux OS 201 includes or provides a Java development environment 202. The Java development environment 202 includes a Java compiler 204. The Linux OS 201 stores a Java source code 203 that has been prepared by a user. The Java compiler 204 is a program for compiling the Java source code 203 to generate a Java bytecode 205. The Java compiler 204 is preferably javac. The Java bytecode 205 generated from the Java source code 203 by the Java compiler 204 is stored by the Linux OS 201. The Java bytecode 205 is preferably a class file, a jar archive, or the like.

The Java development environment 202 is a system that executes the Java bytecode 205. This Java development environment 202 is a system in which, when an extended instruction set architecture (ISA) supported by the CPU 101 is not designated in a command line argument for the system, the just-in-time compiler cannot generate an optimal native code for the extended ISA supported by the CPU 101. An example of such a Java development environment 202 is OpenJDK described in https://wiki.openjdk.org/display/RISCVPort.

The Java development environment 202 further includes a Java virtual machine 208. The Java virtual machine 208 is preferably a java command included in the Java development environment 202. The Java virtual machine 208 includes an interpreter 209 and a dynamic compiler 210, and can generate a native code 211 therein. The native code 211 is preferably a machine language of the RISC-V CPU.

The Linux OS 201 further includes or provides a Java virtual machine calling unit 206 and an ISA-command line correspondence table 207. The Java virtual machine calling unit 206 includes a program that automatically sets the extended ISA in the command line argument of the Java development environment 202 by referring to the ISA-command line correspondence table 207.

### CPU

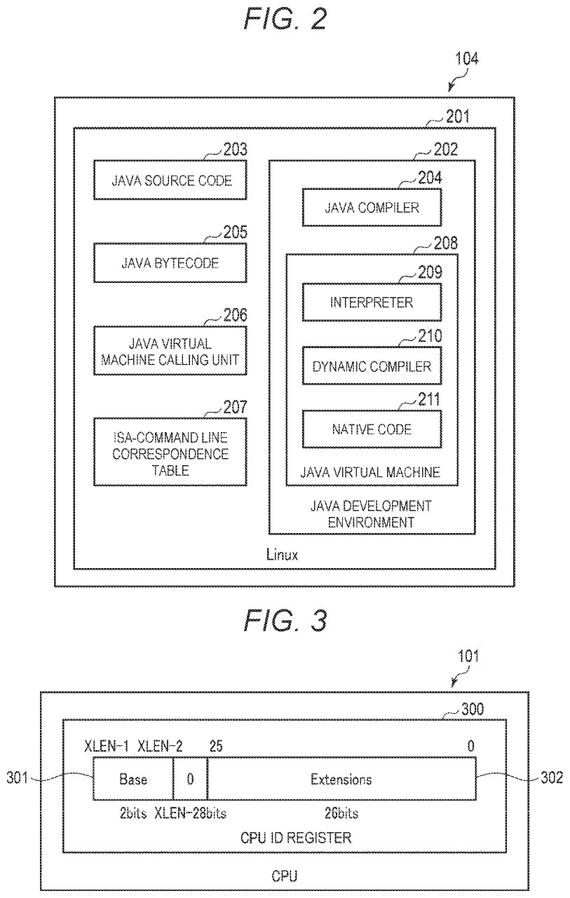

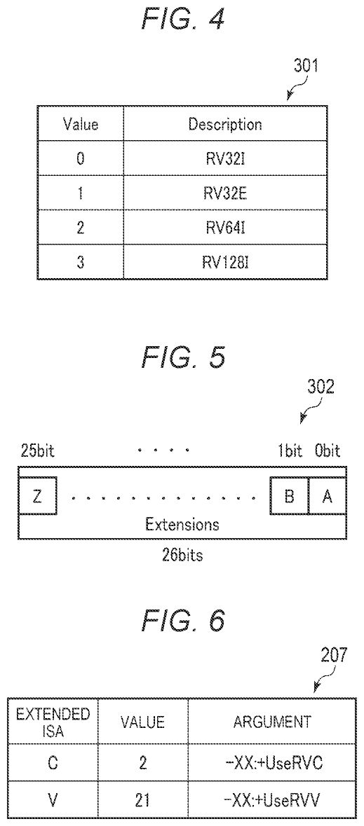

Next, aspects related to CPU 101 (RISC-V CPU) will be described with reference to FIGS. 3 to 5. FIG. 3 illustrates a CPU ID register 300 included in the CPU 101 (RISC-V CPU). FIG. 4 illustrates a Base field of the CPU ID register 300 (mcpuid). FIG. 5 illustrates an Extensions field of the CPU ID register 300 (mcpuid).

The CPU 101 (RISC-V CPU) includes the CPU ID register 300 as illustrated in FIG. 3. The CPU ID register 300 includes a Base field 301 for a basic ISA and an Extensions field 302 for an extended ISA.

The Base field 301 for the basic ISA is composed of 2 bits. As illustrated in FIG. 4, Description of RV32I, RV32E, RV64I, and RV128I correspond to Value of 0, 1, 2, and 3 in the Base field 301, respectively.

The Extensions field 302 for the extended ISA is composed of 26 bits. As illustrated in FIG. 5, a lowest bit is 0 bit and a highest bit is 25 bit. In other words, the 26 bits are positioned from a right side in an order of 0 bit, 1 bit, . . . and 25 bit. Each bit can be set to a value of 0 or 1. The 0 bit, 1 bit, . . . and 25 bit correspond to characters A, B, . . . and Z, respectively. The characters A, B, . . . and Z represents an extended ISA.

The CPU 101 (RISC-V CPU) can acquire a value of the Base field 301 representing the basic ISA illustrated in FIG. 4 and a value of the Extensions field 302 representing the extended ISA illustrated in FIG. 5 by executing a mcpuid instruction in the machine language.

### ISA-Command Line Correspondence Table

FIG. 6 illustrates the ISA-command line correspondence table 207. The ISA-command line correspondence table 207 shows a correspondence between the value in the Extensions field 302 (representing the extended ISA) and the command line argument necessary for enabling optimization corresponding to the extended ISA in the Java virtual machine 208.

In the ISA-command line correspondence table 207, the extended ISA represents a character of the Extensions field 302, a value represents a bit position corresponding to the character, and an argument represents a command line argument corresponding to the character. That is, the ISA-command line correspondence table 207 indicates the following.

The extended ISA for enabling the optimization in the Java virtual machine 208 corresponds to characters C and V. That is, flags are set for the characters C and V. Further, the bit position corresponding to the character C of the extended ISA is 2, the value of the 2-bit position is 1, and the command line argument of the character C of the extended ISA is −XX:+UseRVC. Further, the bit position corresponding to the character V of the extended ISA is 21, the value of the 21-bit position is 1, and the command line argument of the character V of the extended ISA is −XX:+UseRVV.

### Java Virtual Machine Calling Unit

The Java virtual machine calling unit 206 is a program for causing the CPU 101 to implement a function of acquiring an ISA supported by the CPU 101, a function of acquiring an extended ISA from the acquired ISA, a function of automatically setting the extended ISA in the command line argument of the Java development environment 202 by referring to the ISA-command line correspondence table 207, and a function of generating an optimal native code for the extended ISA.

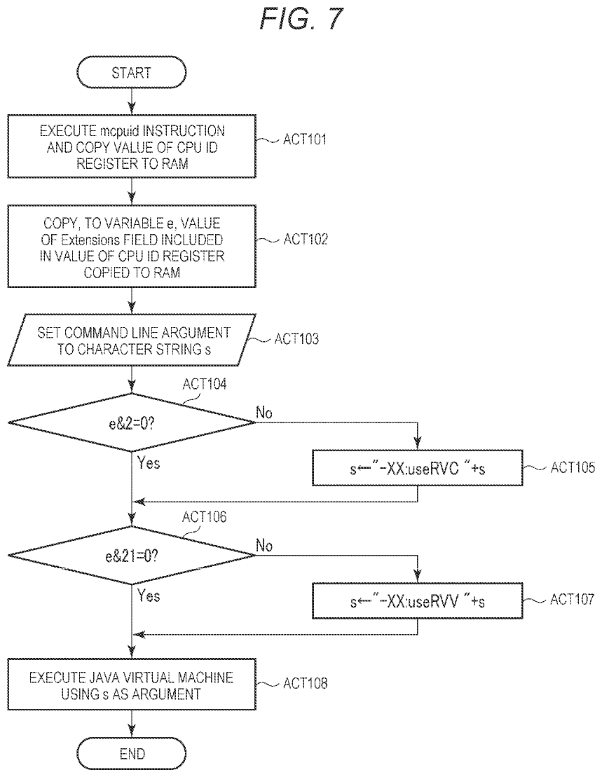

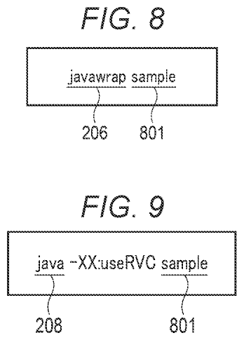

Hereinafter, an operation example of a Java virtual machine calling unit 206 will be described with reference to FIGS. 7 to 9. FIG. 7 is a flowchart illustrating a process executed by the Java virtual machine calling unit 206. FIG. 8 illustrates an execution command of the Java virtual machine calling unit 206. FIG. 9 illustrates an example of a command for calling the Java virtual machine 208.

In this operation example, as shown in FIG. 8, the user attaches an argument 801 (indicated in FIG. 8, and referred to in the following as “sample”) from a command line, and executes a javawrap command representing the Java virtual machine calling unit 206. Here, the Java bytecode 205 is sample.class, and a character string of the sample (as the argument 801) represents that the sample.class is to be executed.

By executing the javawrap command, the Java virtual machine calling unit 206 causes the CPU 101 to perform the following processes.

In ACT 101, the CPU 101 executes the mcpuid instruction and copies the value of the CPU ID register 300 to the RAM 103.

In ACT 102, the CPU 101 copies, to a variable “e”, the value of the Extensions field 302 included in the value of the CPU ID register 300 that was copied to the RAM 103.

In ACT 103, the CPU 101 sets the command line argument to a character string “s”.

In ACT 104, the CPU 101 determines whether e&2=0 by referring to the ISA-command line correspondence table 207. In this context, the operation “e&2” means a bit calculation for checking whether a flag is set in the character C corresponding to the 2-bit position in the variable e. Specifically, the value of the 2-bit position in the variable e is compared with the value of the 2-bit position in the ISA-command line correspondence table 207, and the e&2 returns 0 when any one of the values is 0.

When a determination result in ACT 104 is No, that is, when e&2=0 is not satisfied, the value of the 2-bit position in the variable e and the value of the 2-bit position in the ISA-command line correspondence table 207 are both 1, which indicates that the character C of the extended ISA corresponding to the 2-bit position enables the optimization in the Java virtual machine 208. In this case, next in ACT 105, the character string s is changed to −XX:+UseRVC+s. Thereafter, the process proceeds to ACT 106.

When the determination result in ACT 104 is Yes, that is, when e&2=0 is satisfied, either the value of the 2-bit position in the variable e or the value of the 2-bit position in the ISA-command line correspondence table 207 is 0, which indicates that the character C of the extended ISA corresponding to the 2-bit position does not enable the optimization in the Java virtual machine 208. In this case, the process in ACT 105 is skipped, and the process proceeds to ACT 106.

In ACT 106, the CPU 101 determines whether e&21=0 by referring to the ISA-command line correspondence table 207. In this context, the operation “e&21” means a bit calculation for checking whether a flag is set in the character V corresponding to the 21-bit position in the variable e. Specifically, the value of the 21-bit position in the variable e is compared with the value of the 21-bit position in the ISA-command line correspondence table 207, and the e&21 returns 0 when any one of the values is 0.

When a determination result in ACT 106 is No, that is, when e&21=0 is not satisfied, the value of the 21-bit position in the variable e and the value of the 21-bit position in the ISA-command line correspondence table 207 are both 1, which indicates that the character V of the extended ISA corresponding to the 21-bit position enables the optimization in the Java virtual machine 208. In this case, next in ACT 107, the character string s is changed to −XX:+UseRVV+s. Thereafter, the process proceeds to ACT 108.

When the determination result in ACT 106 is Yes, that is, when e&21=0 is satisfied, either the value of the 21-bit position in the variable e or the value of the 21-bit position in the ISA-command line correspondence table 207 is 0, which indicates that the character V of the extended ISA corresponding to the 21-bit position does not enable the optimization in the Java virtual machine 208. In this case, the process in ACT 107 is skipped, and the process proceeds to ACT 108.

In ACT 108, the CPU 101 executes a java command representing the Java virtual machine 208 using the set character string s as an argument. FIG. 9 illustrates an example of a command for calling the Java virtual machine 208. The command illustrated in FIG. 9 is a command when the determination result in ACT 104 was No but the determination result in ACT 106 was Yes in the flowchart illustrated in FIG. 7. In this example, −XX:+UseRVC, which is a command line argument for enabling the optimization in the Java virtual machine 208, is used with “sample” (argument 801).

When both the determination result in ACT 104 and the determination result in ACT 106 are Yes, the argument 801 of the java command is just “sample”. When the determination result in ACT 104 is Yes but the determination result in ACT 106 is No, the java command line argument is a −XX:+UseRVV sample. When both the determination result in ACT 104 and the determination result in ACT 106 are No, the java command line argument is a −XX:+UseRVV−XX:+UseRVC sample.

As described above, the Java development environment 202 can generate an optimal native code for the extended ISA by executing the java command with an argument for enabling the optimization in the Java virtual machine 208.

### Effect

As can be seen from the above description of an embodiment, it is possible to cause a computer including a system that executes a bytecode and in which optimization is not performable when an extended ISA supported by a CPU is not expressly designated in a command line argument of the system to generate an optimal native code for the extended ISA.

In an embodiment, an environment using java is exemplified as the system that executes a bytecode for which optimization is not performable when an extended ISA supported by a CPU is not designated in a command line argument, but the disclosure is not limited thereto, and can be applied to environments using other programming languages such as Python.

A program according to an embodiment may be transferred stored in an electronic apparatus or otherwise. A program of an embodiment may be transferred via a network or stored in a storage medium. In this context, the storage medium is a non-transitory tangible medium that is a computer-readable medium. The storage medium may be any medium such as a CD-ROM or a memory card as long as the medium can store a program and can be read by a computer, and a form thereof is not limited.

Although the embodiment according to the disclosure is described above, the embodiment is presented as an example and is not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the exemplary embodiments.

What is claimed is:

1. A computer, comprising:
a central processing unit (CPU); and
a storage device storing an operating system that executes a bytecode without optimization for an extended ISA supported by the CPU unless the extended ISA is designated in a command line argument for executing the bytecode, wherein
the storage device further stores:
a correspondence table showing a correspondence between a value of an extension field indicating the extended ISA and the command line argument enabling optimization corresponding to the extended ISA, and
a program configured to cause the CPU to:
acquire an ISA supported by the CPU,
acquire the extended ISA from the ISA,
refer to the correspondence table to acquire the command line argument associated with the extended ISA, and
automatically include the command line argument associated with the extended ISA when executing the bytecode.

2. The computer according to claim 1, wherein the program is further configured to cause the CPU to generate a native code optimal for the extended ISA from the bytecode upon receiving the command line argument associated with the extended ISA.

3. The computer according to claim 1, wherein the operating system is a Linux-based operating system.

4. The computer according to claim 1, wherein the operating system is a Debian GNU operating system.

5. The computer according to claim 1, wherein the CPU is a RISC-V CPU.

6. The computer according to claim 1, wherein the bytecode is a Java bytecode generated from Java source code by a Java compiler implemented by the operating system.

7. The computer according to claim 1, wherein the bytecode is executed in a Java development environment.

8. The computer according to claim 7, wherein the Java development environment includes a Java virtual machine.

9. A computer, comprising:
a central processing unit (CPU) supporting an extended ISA and executing an operating system that provides a Java development environment including a Java compiler and a Java virtual machine; and
a storage device accessible by the CPU, the storage device storing a correspondence table indicating a correspondence between a value of an extension field indicating the extended ISA and a command line argument enabling optimization corresponding to the extended ISA of native code compiled by the Java compiler from a bytecode to be executed on the Java virtual machine by the CPU, wherein
the operating system is configured to:
refer to the correspondence table to acquire the command line argument associated with the extended ISA of the CPU, and
automatically include the command line argument associated with the extended ISA for executing the bytecode in the Java development environment.

10. The computer according to claim 9, wherein the operating system is a Linux-based operating system.

11. The computer according to claim 9, wherein the CPU is a RISC-V CPU.

12. A method for generating an optimal native code in a system that executes a bytecode but does not perform native code optimization unless an extended ISA supported by a CPU is designated in a command line argument of the system, the method comprising:
acquiring an ISA supported by a CPU;
acquiring the extended ISA from the ISA;
referring to a correspondence table showing a correspondence between a value of an extension field representing the extended ISA and a command line argument for enabling optimization corresponding to the extended ISA;
automatically setting the command line argument indicating the extended ISA for executing the bytecode; and
generating an optimal native code for the extended ISA from the bytecode.

13. The method according to claim 12, wherein the system is part of a Linux-based operating system.

14. The method according to claim 13, wherein the Linux-based operating system is a Debian GNU operating system.

15. The method according to claim 12, wherein the CPU is a RISC-V CPU.

16. The method according to claim 12, wherein the bytecode is a Java bytecode generated from Java source code by a Java compiler.

17. The method according to claim 12, wherein the bytecode is executed in a Java development environment.

18. The method according to claim 17, wherein the Java development environment includes a Java virtual machine.
